(19) United States
(12) Patent Application Publication
(10) Pub. No.: US 2008/0287127 A1
(43) Pub. Date: Nov. 20, 2008

(54) FORWARD ACCESS CHANNEL MEASUREMENT OCCASION SCHEDULING DEVICE

(75) Inventors: Ping Wu, Hoffman Estates, IL (US); Donald A. Dorsey, Vernon Hills, IL (US); Sharada Raghuram, Buffalo Grove, IL (US)

Correspondence Address: BRINKS HOFER GILSON & LIONE, P.O. BOX 10395, CHICAGO, IL, 60610, US

(73) Assignee: Motorola, Inc., Schaumburg, IL (US)

(21) Appl. No.: 11/748,901

(22) Filed: May 15, 2007

(51) Int. Cl. H04Q 7/20; H04B 1/38

(52) U.S. Cl. 455/434; 455/73

(57) ABSTRACT

A wireless device (105) for scheduling a forward access channel measurement occasion (FMO) includes a transmitter (202) to transmit radio signals required to perform random access channel (RACH) transmission (RACHing) and report the results of cell measurements. A receiver receives radio signals required to acquire information blocks, serving cell selection criteria, and measurement rule parameters, and to measure at least one of inter-frequency and inter-radio access technology (inter-RAT) neighbor cells. A scheduling module (212, 214, 216) schedules FMO frames for neighbor cell measurement in order to prioritize FMO frames that collide with a position of an information block or that collide with RACHing.

### BACKGROUND

This disclosure relates to third generation (3G) wireless networks. In particular, the disclosure relates to a system for scheduling a forward access channel measurement occasion.

When in CELL Forward Access Channel (FACH) state, a FACH Measurement Occasion (FMO) is a time gap that a user equipment (UE) can use to measure inter-frequency neighbor cells and inter-radio access technology (inter-RAT) neighbor cells. The network will configure FMO parameters in broadcasting system information blocks.

When in IDLE mode, a measurement rule is used to decide if a UE needs to measure inter-frequency neighbor cells and inter-RAT neighbor cells. The network will also configure Measurement Rule parameters in broadcasting system information blocks.

While in CELL_FACH state, FMO frames are a limited resource and are the only time intervals (or frames) that can be used to measure inter-RAT neighbor cells and inter-frequency neighbor cells at a single receiver phone. When there are both inter-frequency and inter-RAT neighbor cells to be measured, FMO scheduling becomes pivotal in a UE measuring and reselecting cells of another frequency or cells of another RAT, especially when the UE is on the fringe of current UTRAN (Universal Mobile Telecommunication System (UMTS) Terrestrial Radio Access Network) frequency coverage. However, in the Third Generation Partnership Project (3GPP) standard, no FMO scheduling algorithm is specified or recommended.

### BRIEF DESCRIPTION OF THE DRAWINGS

Non-limiting and non-exhaustive embodiments of the disclosure are described, including various embodiments of the disclosure with reference to the below Figures.

FIG. 1 is a block diagram of an example third generation (3G) UTRAN (Universal Terrestrial Radio Access Network) wireless communications network.

FIG. 2 is a schematic block diagram of an example wireless device for implementing an FMO scheduling system.

FIG. 3 illustrates an exemplary process for scheduling reading a master or system information block (MIB/SIB) when RACH transmission frames collide with FMO time frames.

FIG. 4 illustrates an exemplary process for scheduling a random access channel (RACH) transmission when the maximum time frames needed for RACH collide with FMO time frames.

FIG. 5 illustrates an exemplary process for scheduling FMO time frames, whether dedicated to inter-radio access technology (inter-RAT) neighbor cells, inter-frequency neighbor cells, or to both.

### DETAILED DESCRIPTION

By using timing and collision information, various signal strength measurements that track a serving cell selection criterion (S), and neighbor cell measurement rules, an FMO scheduling system prioritizes the usage of FMO frames to improve user equipment's (UE) ability to measure inter-frequency and inter-RAT neighbor cells. Because FMO frames are limited, the FMO scheduling system improves a UE's performance, especially when it is on a fringe of coverage, by creating an algorithm for inter-frequency and inter-RAT neighbor cell measurements.

In a first embodiment, an FMO scheduling system determines how to process an information block received from a wireless network when Forward Access Channel (FACH) Measurement Occasion (FMO) frames collide with the information block position. If a collision occurs and a serving cell selection criterion is greater than zero, then the information block has priority. Otherwise, FMO has priority over the information block. Otherwise, inter-frequency and inter-RAT neighbor cell measurements have priority over reading the information block.

In a second embodiment, the FMO scheduling system schedules random access channel (RACH) uplink transmissions (RACHing) when the maximum time frames needed for RACH collide with FMO time frames. The scheduling system determines a priority of inter-frequency and inter-RAT neighbor cell measurements and a random access channel transmission (RACH) mode based on serving cell selection criterion and a recurrence of the FMO. If the serving cell selection criterion is less than a predetermined threshold value or the FMO is infrequent, inter-frequency and inter-RAT neighbor cell measurements have priority. Otherwise, RACH has priority.

In a third embodiment, the FMO scheduling system re-uses parameters of a measurement rule from IDLE and paging channel (PCH) states. The FMO scheduling system determines a mode to measure based on a measurement rule and a neighbor cell list. If the measurement rule or a neighbor cell list requires neighbor cell measurements, a user equipment (UE) will choose one of inter-frequency and inter-radio access technology (inter-RAT) modes to measure based on determined serving cell selection criterion threshold values of the respective modes. The scheduling system of the three embodiments may be integrally-linked and accommodate varying signal strengths, RACH modes, and information block frames.

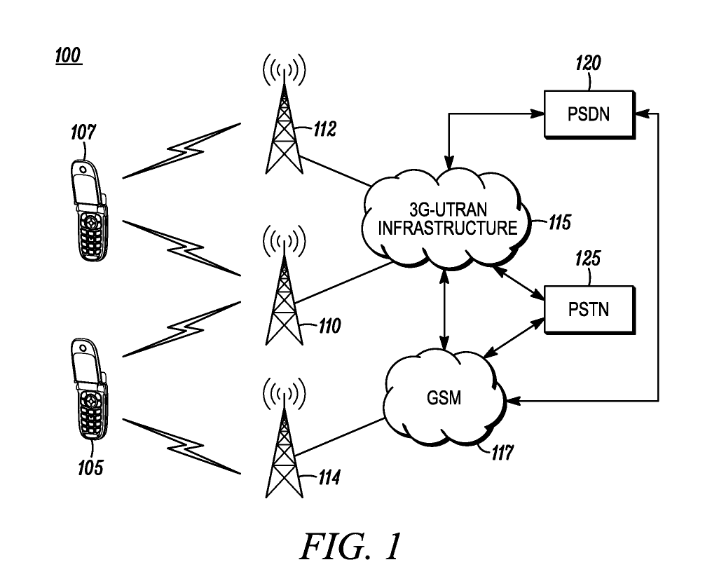

FIG. 1 is a schematic block diagram of a third generation (3G) UTRAN (Universal Terrestrial Radio Access Network) wireless communications network 100. The network 100 includes a wireless UE 105, a base transceiver station (BS) 110, an inter-frequency neighbor cell 112, an inter-radio access technology (inter-RAT) neighbor cell 114, a 3G-UTRAN (3G) network infrastructure 115 that uses code-division multiple access (CDMA), a Public Switched Data Network (PSDN) 120, and a Public Switched Telephone Network (PSTN) 125. The inter-RAT neighbor cell 114 connects through a Global System for Mobile Communications (GSM) network 117, which uses time division multiple access (TDMA).

The UE 105 may be a cellular telephone configured to operate in accordance with 3G protocols. The network 100 may include other devices, such as UE 107, that transmit and receive data signals interoperable with 3G protocols. The BS 110 contains radio frequency transmitters and receivers used to communicate directly with the UEs 105, 107. In this type of cellular network, the UEs do not communicate directly with each other but communicate with the BSs 110, also referred to as serving cells.

The 3G network infrastructure 115 includes components that connect the UE 105 and the BS 110 with other components, such as the PSDN 120 and the PSTN 125. The 3G network infrastructure 115 includes support nodes, servers, and gateways operable to transmit the data carried within the 3G network infrastructure 115 and between the UE 105 and the PSDN 120 and/or the PSTN 125.

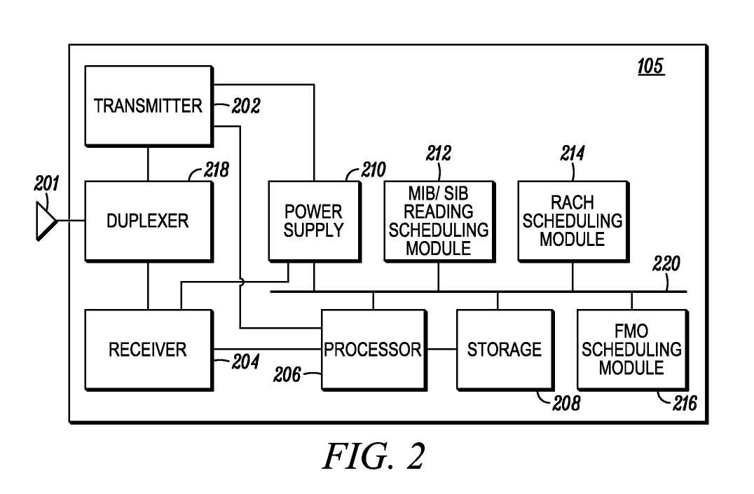

FIG. 2 illustrates a schematic block diagram of an example UE 105. The UE 105 includes an antenna 201, a transmitter 202, a receiver 204, a processor 206, a storage 208, a power supply 210, a master (or system) information block (MIB/SIB) reading scheduling module 212, a RACH scheduling module 214, an FMO scheduling module 216, and a duplexer 218. In this embodiment, the antenna 201 is coupled to both the transmitter 202 and the receiver 204 through the duplexer 218. Alternatively, the transmitter 202 and the receiver 204 may be connected to respective antenna units.

As shown in this embodiment, the processor 206, the storage 208, the power supply 210, and the scheduling modules 212, 214, 216 electrically communicate through a communications bus 220. The communications bus 220 is operable to transmit control and communications signals from and between the components connected to the bus 220, such as power regulation, memory access instructions, and other system information. In this embodiment, the processor 206 is coupled to the receiver 204 and to the transmitter 202. One of skill in the art will appreciate that the processor 206 may include the scheduling modules 212, 214, and 216, which may be executed through software, hardware, or a combination thereof.

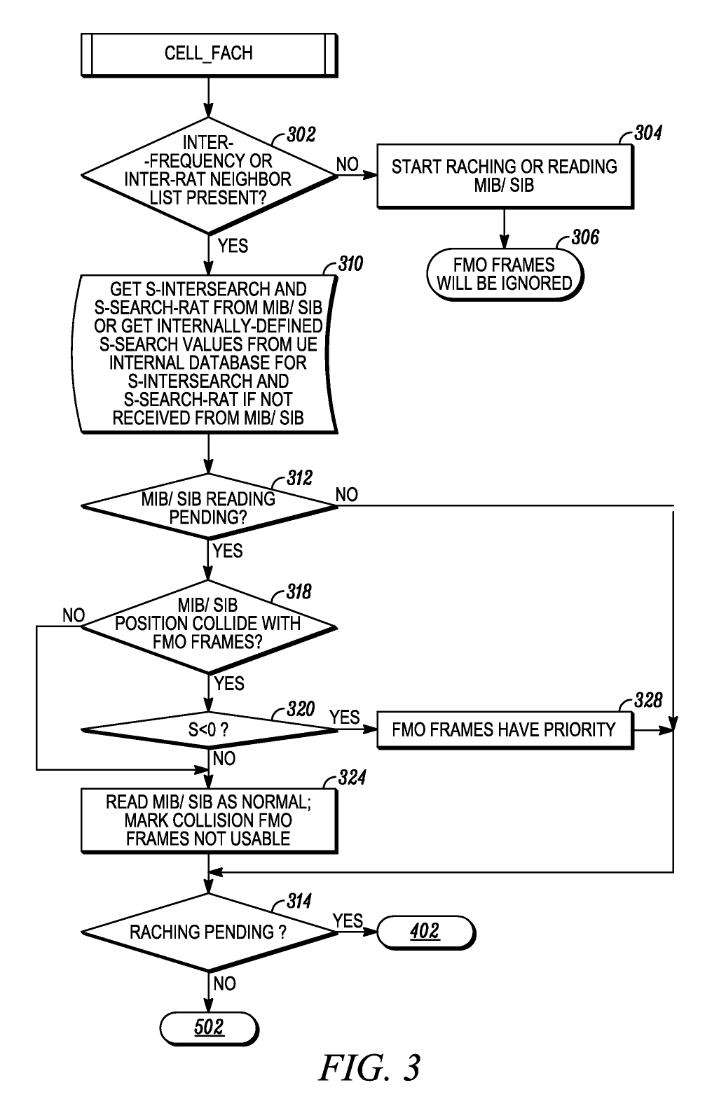

The UE 105 is configured to maintain a schedule for MIB/SIB, RACH, and FMO based on measurement rules and network conditions. Several terms are now explained to provide context for FIGS. 3 through 5. When the UE 105 is in a FACH state, the UE in Frequency Division Duplex (FDD) mode performs measurements during the frame(s) with the System Frame Number (SFN) value to fulfill:

SFN div N=C_{—}RNTI mod M_{—}REP+n*M_{—}REP.

In the above equation, N is the transmission time interval (TTI) in number of 10 ms frames of the FACH having the largest TTI on the Secondary Common Control Physical Channel (SCCPCH) selected by the UE 105. FACHs that only carry Multi-media Broadcast/Multi-cast Service (MBMS) logical channels (MTCH, MSCH, or MCCH) are excluded from measurement occasion calculations. C_RNTI is the channel Radio Network Temporary Identity (C-RNTI) value of the UE stored in the variable C_RNTI. M_REP is the Measurement Occasion cycle length. According to the equation above, a FMO of N frames will be repeated every N*M REP frames (or an FMO gap repeating interval), and M_REP=2^{k} where k is the FMO cycle length coefficient.

The value of the FMO cycle length coefficient is read in system information in “System Information Block type 11” or “System Information Block type 12” in the information element (IE) “FACH measurement occasion information.” The value N=0, 1, 2 . . . as long as SFN is below its maximum value. The UE 105 is allowed to measure on other occasions in case the UE moves “out of service” area or in case it can simultaneously perform the ordered measurements.

In an exemplary embodiment, the MIB/SIB reading scheduling module 212 (or scheduling module 212) is configured to check if FMO frames collide with the position of an information block, whether from a MIB or a SIB. The MIB may include data related to SIBs used in a serving cell (e.g., BS 110). The SIB may include data related to serving cell transmission parameters.

If there is a collision, the scheduling module 212 checks to see if a serving cell selection criterion (S) is less than zero. In serving cell selection, cells that are FDD require that both S_{qual} and Sᵣₓₗₑᵥ values be greater than zero for S to be fulfilled. Here, S_{qual} is the cell selection quality value in decibels (dB) and Sᵣₓₗₑᵥ is the cell selection RX (reception) level value in decibels (dB) as determined by the following:

S_{qual}=Q_{qualmeas}−Q_{qualmin}; and

Sᵣₓₗₑᵥ=Qᵣₓₗₑᵥₘₑₐₛ−Qᵣₓₗₑᵥₘᵢₙ−P_{compensation}.

In the above formulas, Q_{qualmeas} is the measured cell quality value (dB); Q_{qualmin} is the minimum required quality level in the cell (dB); Qᵣₓₗₑᵥₘₑₐₛ is the measured cell RX level value (dBm); Qᵣₓₗₑᵥₘᵢₙ is the minimum required RX level in the cell (dBm); and P_{compensation} is the maximum TX (transmission) power level a UE 105 may use when accessing the cell on RACH (read in system memory) (dBm). The quality of a received signal (Q_{qualmeas}) from a cell is expressed in CPICH (common pilot channel) E_{c}/N₀ (dB) for FDD cells, where E_{c}/N₀ is the measured average of a cell's energy in IDLE mode.

If an S value is greater than zero and there is a collision between FMO frames and a position of an information block, then the scheduling module 212 gives information blocks priority over neighbor cell measurement and marks the collision FMO frames as unusable. The remainder of the FMO frames may be used for neighbor cell measurement. If S is less than zero, there is a good chance that the UE 105 cannot read the information block successfully and the FMO frames are made available for measuring inter-frequency and/or inter-RAT neighbor cells. Otherwise, if there is no collision, the information blocks (MIB/SIB) are read as normal.

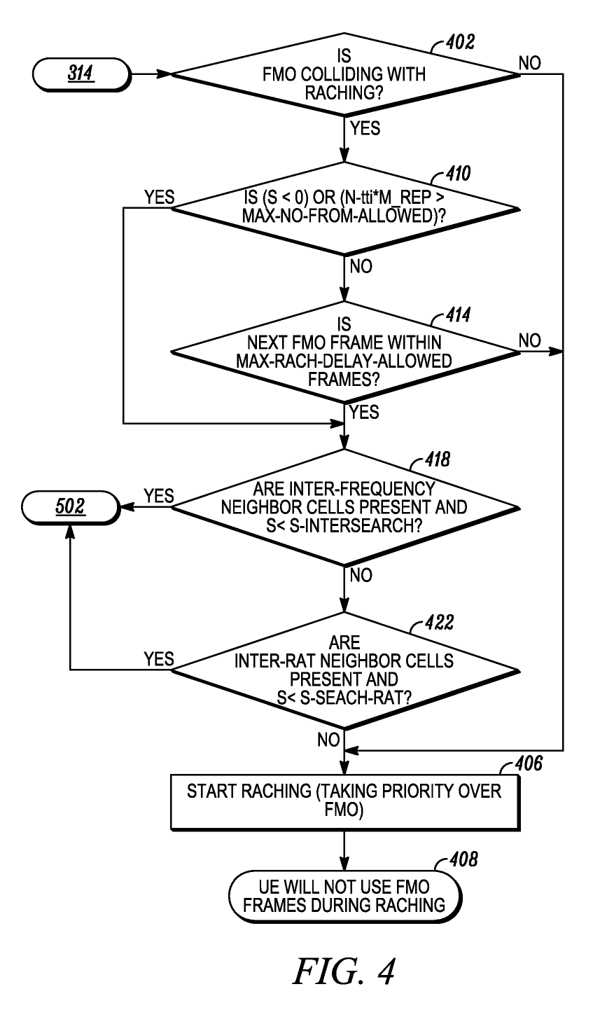

In another exemplary embodiment, the RACH scheduling module 214 (or scheduling module 214) is configured to determine whether to prioritize RACHing or neighbor cell measurement when FMO frames collide with RACH frames. That is, the scheduling module 214 determines if there are FMO frames within MAX-RACH-NEEEDED frames, where MAX-RACH-NEEEDED frames is a predetermined value indicating a number of frames during which RACHing can last. Further steps are taken by the scheduling module 214 within this process to determine whether RACH takes priority over FMO, and is explained in detail with reference to FIG. 4.

In a further exemplary embodiment, the FMO scheduling module 216 (or scheduling module 216) uses FMO frames received at the UE 105 to perform an inter-RAT neighbor cell measurement or an inter-frequency neighbor cell measurement when more than one network mode requires measurement based on a network cell neighbor list and a cell measurement rule. The scheduling module 216 uses the FMO frames to perform both the inter-RAT cell measurement and the inter-frequency cell measurement when both network modes require measurement. The scheduling module 216 does not use FMO frames to perform the inter-RAT cell measurement or the inter-frequency cell measurement during a RACH transmission mode when the RACH transmission mode has a higher priority over the FMO (which priority is determined by the RACH scheduling module 214) or during reception of an information block if it has priority, as determined by the MIB/SIB reading scheduling module 212.

The scheduling module 216 may use one or more threshold parameters when scheduling the FMO. S-INTERSEARCH is a threshold value that UE 105 compares with S_{qual} (as determined above) to check whether inter-frequency cells 112 need to be measured when applying a measurement rule. S-SEARCH-RAT is a threshold value that UE 105 compares with S_{qual} to check whether inter-RAT neighbor cells 114 need to be measured when applying a measurement rule.

The FMO scheduling module 216 uses a MAX-RACH-NEEDED value as the maximum length of time that RACHing takes under good radio conditions (the value may vary based on RACH parameters in a SIB). The scheduling module 216 also uses a MAX-ALLOWED-RACH-DELAY value as the maximum length of time that RACHing can be delayed under good radio conditions and when FMOs occur at more than a determined frequency. MAX-ALLOWED-RACH-DELAY will usually be much less than MAX-RACH-NEEDED. The scheduling module 216 uses a MAX-NO-FMO-ALLOWED value as the maximum length of time (between two FMOs) that is acceptable to delay an FMO.

One of skill in the art will appreciate that scheduling modules 212, 214, and 216 may be combined into a single MIB/SIB, RACH, and FMO scheduling module to control priority and resolve conflicts as hereafter described.

FIG. 3 illustrates an exemplary process for scheduling reading a MIB/SIB information block when its position collides with FMO time frames during CELL_FACH state. The MIB/SIB reading scheduling module 212 of UE 105 determines, at step 302, whether there is an inter-frequency or inter-RAT neighbor cell list present. If there is not, the UE will start RACHing or reading the information block (from the MIB or SIB), at step 304, and the FMO frames will be ignored, at step 306.

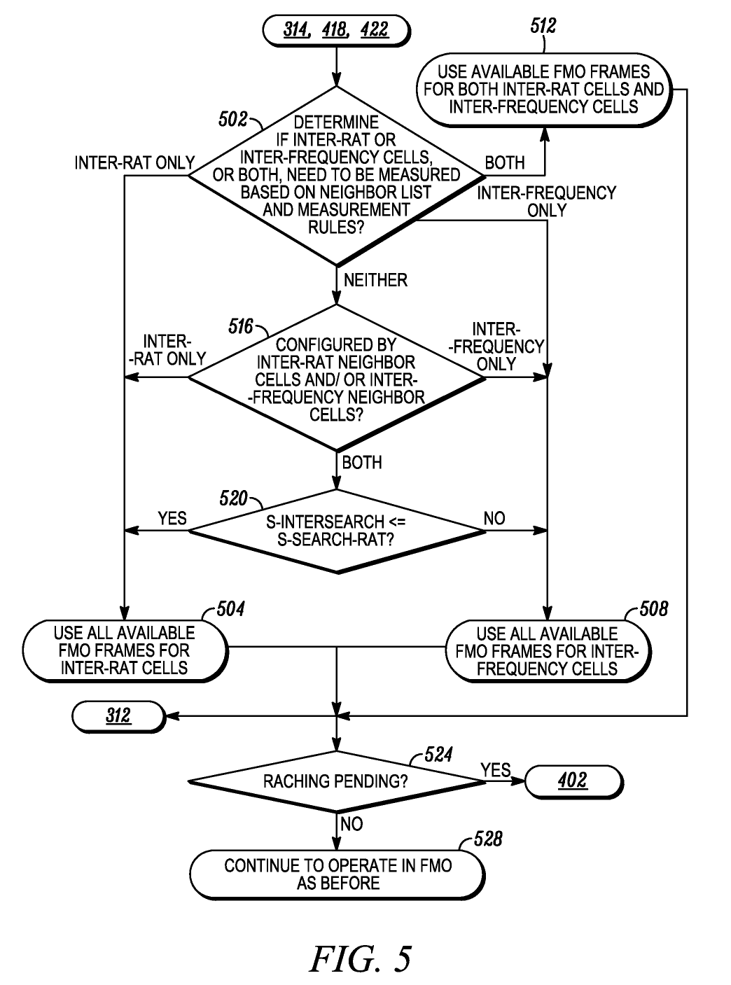

If, however, there is an inter-frequency or inter-RAT neighbor cell list present, at step 302, one or both of the corresponding S-INTERSEARCH and S-SEARCH-RAT parameters are retrieved from the MIB/SIB of a serving cell, at step 3 10. In the alternative, the scheduling module 212 obtains internally defined S-SEARCH values from a UE-internal database for S-INTERSEARCH and S-SEARCH-RAT if they were not received over the network 115 from an information block. The scheduling module 212 determines if information block reading is pending, at step 312. If there is none pending, then the scheduling module 212 decides if RACHing is pending, at step 314. If RACHing is pending, the process continues to step 402 (FIG. 4), and if not, the process continues to step 502 (FIG. 5).

If the scheduling module 212 determines that an information block read is pending, at 312, it goes on to determine if an information block position collides with any FMO frames, at step 318. If the information block position collides with FMO frames, the scheduling module 212 determines if a serving cell selection criterion (S) value is less than a predetermined threshold value, such as zero, at step 320. If the S value is not less than a predetermined threshold value or if the information block position does not collide with FMO frames at step 318, then the scheduling module 212 reads the information block (MIB/SIB) as normal, at step 324. Additionally, the collision FMO frames from step 318 are marked as unusable, at step 324, but the scheduling module 212 still allows the remainder of the FMO frames to be used for measurement.

Alternatively, if the information block position collides with FMO frames at step 318, and the S value is less than a predetermined threshold value, at step 320, then the FMO has priority. The scheduling module 212 then determines, once again, if RACHing is pending, at step 314. If RACHing is pending, the scheduling module 212 continues to step 402 (FIG. 4). If RACHing is not pending, the scheduling module 212 continues to step 502 (FIG. 5).

FIG. 4 illustrates an exemplary process for scheduling a random access channel (RACH) transmission when the maximum time frames needed for RACHing collide with FMO time frames. The RACH scheduling module 214 of the UE 105 determines, at step 402, if an FMO is colliding with RACHing, such as when there are FMO frames within MAX-RACH-NEEDED frames. If the FMO does not collide with RACHing, the scheduling module 214 starts RACHing, at step 406. The scheduling module 214 assigns priority to RACHing in this case, and the UE 105 will not use the FMO frames during RACHing, at step 408.

If the FMO is colliding with RACHing per step 402, the scheduling module 214 then determines if a cell selection criterion S is less than a predetermined value, such as zero, or if N-tti*M_REP is greater than MAX-NO-FMO-ALLOWED, at step 410. In this equation, N-tti is the transmission time interval (TTI) in number of 10 ms frames of the FACH having the largest (or maximum) TTI on the SCCPCH selected by the scheduling module 214. As before, M_REP=2^{k} where k is the FMO cycle length coefficient. Finally, MAX-NO-FMO-ALLOWED is the value that equals the maximum length of time (between two FMOs) that is acceptable to delay an FMO. It is likely that the UE 105 cannot RACH successfully if S is less than the predetermined threshold value (such as zero), and it is likely that the UE 105 will lose coverage if the FMO is not used to find a neighbor cell.

If S is greater than or equal to the predetermined threshold value and if N-tti*M_REP is greater than or equal to MAX-NO-FMO-ALLOWED, then the scheduling module 214 determines, at step 414, if a next FMO frame is within the MAX-RACH-DELAY-ALLOWED frames value. If the determined threshold value S is less than a predetermined value, such as zero, or if Ntti*M_REP is greater than MAX-NO-FMO-ALLOWED, the scheduling module 214 determines if inter-frequency neighbor cells 112 are present and if S is less than a determined S-INTERSEARCH value, at step 418. Because an FMO frame is infrequent, when Ntti*M_REP is greater than MAX-NO-FMO-ALLOWED, the scheduling module 214 will not get a chance to measure inter-frequency or inter-RAT neighbor cells 112, 114 for a long time if the UE 105 does not give the FMO priority over RACHing.

If the next FMO frame is within the MAX-RACH-DELAY-ALLOWED frames value, at step 414, the scheduling module 214 continues to step 418. If the next FMO frame is not within the MAX-RACH-DELAY-ALLOWED frames value, the scheduling module 214 continues to step 406. If inter-frequency neighbor cells 112 are present and if S is less than a determined S-INTERSEARCH value, at step 418, the scheduling module 214 continues to step 502 (FIG. 5).

If inter-frequency neighbor cells 112 are not present or if S is greater than or equal to an S-INTERSEARCH value, the scheduling module 214 determines if inter-RAT neighbor cells 114 are present and if S is less than an S-SEARCH-RAT value, at step 422. If inter-RAT neighbor cells 114 are not present or if S is greater than or equal to the S-SEARCH-RAT value, the scheduling module 214 continues to step 406, where RACHing begins. The UE 105 then does not use FMO frames during RACHing, at step 408. If inter-RAT neighbor cells 114 are present and if S is less than the S-SEARCH-RAT value, at step 422, the UE 105 continues to step 502 (FIG. 5). Thus, FIG. 4 provides an example of how to prioritize RACH and neighbor cell measurements during an FMO frame.

FIG. 5 illustrates an exemplary process for scheduling FMO time frames, whether dedicated to inter-RAT neighbor cells 114, inter-frequency neighbor cells 112, or to both. Remember that the process described herein reaches FIG. 5 if RACHing was not pending at step 314 in FIG. 3, if inter-frequency neighbor cells 112 are present and the value of S was less than S-INTERSEARCH at step 418 (FIG. 4), or if inter-RAT neighbor cells 114 are present and the value of S is less than S-SEARCH-RAT at step 422 (FIG. 4). At least in any of these three cases, the FMO scheduling module 216 of the UE 105 determines whether inter-RAT or inter-frequency neighbor cells 112, 114, or both, need to be measured, at step 502, based on neighbor cell lists and measurement rules.

If only inter-RAT neighbor cells 114 are present and require measurement, the scheduling module 216 will use all available FMO frames to measure inter-RAT neighbor cells 114, at step 504. On the other hand, if only inter-frequency neighbor cells 112 are present and require measurement, the scheduling module 216 will use all available FMO frames to measure inter-frequency cells, at step 508. But, if both inter-RAT and inter-frequency cells 114, 112 are present, and based on the neighbor lists and a measurement rule both require measurement, then the scheduling module 216 will use all available FMO frames for measurement of both inter-RAT and inter-frequency neighbor cells 114, 112, at step 512.

If, at step 502, it is determined, based on available neighbor lists and a measurement rule, that neither present inter-RAT nor present inter-frequency neighbor cells 114, 112 require measurement, the scheduling module 216 then determines if the UE 105 is configured by inter-RAT and/or inter-frequency neighbor cells 114, 112, at step 516. Here, “configured” means that the UE 105 has received all neighbor lists of the inter-RAT and inter-frequency neighbor cells 114, 112 in the network 115. A neighbor list may come through decoding a MIB/SIB transmission received from a serving cell.

If only inter-RAT neighbor cells 114 are configured, the UE 105 then continues to step 504 where the scheduling module 216 uses all available FMO frames for inter-RAT neighbor cell 114 measurements. If only inter-frequency neighbor cells 112 are configured, the scheduling module 216 then continues to step 508 to use all available FMO frames for inter-frequency neighbor 212 cell measurements. If both inter-RAT neighbor cells 114 and inter-frequency neighbor cells 112 are configured, the scheduling module 216 then determines if S-INTERSEARCH is less than or equal to S-SEARCH-RAT, at step 520. The network mode that has the largest S value will be measured because the larger S value indicates the network 115 will prefer that mode and that is the mode whose threshold will be crossed first if the serving cell deteriorates. If S-INTERSEARCH is less than or equal to S-SEARCH-RAT, the scheduling module 216 continues to step 504. If S-INTERSEARCH is greater than S-SEARCH-RAT, the scheduling module continues to step 508.

If after any of steps 504, 508, or 512 have been completed-a decision of either or both inter-RAT and inter-frequency neighbor cells 114, 112 being measured with FMO frames has been made-then the scheduling module 216 determines whether RACHing is pending, at step 524. If RACHing is pending, then the scheduling module 216 continues to step 402 (FIG. 4). In contrast, if RACHing is not pending, then the UE 105 continues to operate FMO Scheduling as before, making measurement decisions as discussed in FIG. 5.

Additionally, after steps 504, 508, and 512 have been completed, the scheduling module 216 passes to step 312 of FIG. 3 to decide whether or not MIB/SIB reading is pending, and follows the steps described thereafter accordingly.

By prioritizing reading of information blocks when they are likely to be read successfully and prioritizing neighbor cell measurements otherwise, neighbor cell measurements of a scheduling system can be thoughtfully prioritized over RACHing during FMO frames when RACHing is not needed or is not likely to be successful. Finally, FMO frames used for discretionary neighbor cell measurements are allocated between inter-frequency neighbor cells or inter-RAT neighbor cells based on which is likely to be needed the soonest.

In the methods shown in FIGS. 3-5, the flow diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the UE 105, a communication interface, or any other type of non-volatile or volatile memory interfaced or resident to the network 115 or UE 105. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

The order of the steps or actions of the methods described in connection with the embodiments disclosed may be changed as would be apparent to those skilled in the art. Thus, any order in the Figures, such as in the flow diagrams, or in the Detailed Description is for illustrative purposes only and is not meant to imply a required order, except where an order is explicitly required.

The present disclosure is defined by the appended claims. The detailed description summarizes some aspects of the present embodiments and should not be used to limit the claims. While the present disclosure may be embodied in various forms, there are shown in the drawings and described in the detailed description are some exemplary and non-limiting embodiments, with the understanding that the present disclosure is not intended to limit the disclosure to the specific embodiments illustrated. The order of the steps or actions of the methods described in connection with the embodiments disclosed may be changed as would be apparent to those skilled in the art. Thus, any order in the Figures or Detailed Description is for illustrative purposes only and is not meant to imply a required order.

In this application, the use of the disjunctive is intended to include the conjunctive. The use of definite or indefinite articles is not intended to indicate cardinality. In particular, a reference to “the” object or “a and an” object is intended to denote also one of a possible plurality of such objects.

A “computer-readable medium,” “machine-readable medium,” “propagated-signal” medium, and/or “signal-bearing medium” may comprise any module that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While the principles of the disclosure have been described above in connection with specific apparatus, it is to be clearly understood that this description is made only by way of example and not as a limitation on the scope of the disclosure. It is therefore intended that the foregoing detailed description be regarded as illustrative rather than limiting, and that it be understood that it is the following claims, including all equivalents, that are intended to define the spirit and scope of this disclosure.

1. A method for a wireless device to schedule a forward access channel measurement occasion (FMO), comprising:
determining if FMO frames collide with a position of an information block received by the wireless device;
receiving a serving cell selection criterion from a serving cell of the wireless device; and
granting the FMO a higher priority over reading the information block when the FMO frames collide with the position of the information block and when the received serving cell selection criterion is less than a determined threshold value.

2. The method of claim 1, further comprising:
reading the information block when the FMO frames collide with the position of the information block and when the received serving cell selection criterion is greater than or equal to the determined threshold value.

3. The method of claim 2, wherein reading the information block comprises:
marking determined FMO collision frames as unusable; and
using a remainder of available FMO frames for neighbor cell measurement.

4. The method of claim 1, further comprising:
if a random access channel (RACH) transmission (RACHing) is pending, determining if there are FMO frames that collide with RACHing; and
if RACHing collides with the FMO frames, delaying RACHing until the end of a next FMO period when at least one of inter-frequency cells and inter-radio access technology (inter-RAT) cells need to be measured based on a measurement rule and a neighbor list, and upon occurrence of at least one of:
the serving cell selection criterion is less than a determined threshold;
a maximum FMO gap repeating interval is greater than a maximum allowed FMO delay period; and
there are FMO frames within a maximum allowed RACH delay period.

5. The method of claim 1, further comprising:
if a random access channel transmission (RACHing) is not pending, determining that neither inter-radio access technology (inter-RAT) nor inter-frequency cells need to be measured based on available serving cell neighbor lists and a cell measurement rule;
using all available FMO frames to measure inter-RAT neighbor cells if only an inter-RAT neighbor list is received; and
using all available FMO frames to measure inter-frequency neighbor cells if only an inter-frequency neighbor list is received.

6. The method of claim 5, wherein if it is determined that neighbor lists are received for both inter-RAT and inter-frequency neighbor cells, further comprising:
using all available FMO frames to measure inter-RAT cells if a value for S-INTERSEARCH is less than or equal to a value for S-SEARCH-RAT; and
using all available FMO frames to measure inter-frequency cells if the value for S-INTERSEARCH is greater than the value for S-SEARCH-RAT.

7. A method for scheduling a forward access channel measurement occasion (FMO) by determining priority of random access channel (RACH) transmission mode (RACHing) with a wireless device, the method comprising:
determining if there are FMO frames that collide with RACHing;
receiving a serving cell selection criterion from a serving cell of the wireless device; and
if RACHing collides with the FMO frames, delaying RACHing until the end of a next FMO period when at least one of inter-frequency cells and inter-radio access technology (inter-RAT) cells need to be measured based on a measurement rule and a neighbor list, and upon occurrence of at least one of:
the serving cell selection criterion is less than a determined threshold;
a maximum FMO gap repeating interval is greater than a maximum allowed FMO delay period; and
there are FMO frames within a maximum allowed RACH delay period.

8. The method of claim 7, wherein the cell selection criterion is at least one of S_{qual} and Sᵣₓₗₑᵥ.

9. The method of claim 7, wherein delaying RACHing until the end of a next FMO period to measure an inter-frequency cell occurs when the cell selection criterion is less than S-INTERSEARCH

10. The method of claim 7, wherein delaying RACHing until the end of a next FMO period to measure an inter-RAT cell occurs when the cell selection criterion is less than S-SEARCH-RAT.

11. The method of claim 7, further comprising:
assigning priority to RACHing over FMO when there are no FMO frames within a maximum length of time that the RACH transmission mode takes under a predetermined radio condition.

12. The method of claim 11, further comprising:
determining, by the wireless device, at least one of the maximum number of allowed RACH delay frames, the maximum period between two FMOs where it is acceptable to delay the FMO, and the maximum length of time that RACHing takes under a predetermined radio condition.

13. The method of claim 11, wherein the maximum length of time that RACHing takes under the predetermined radio condition is determined based on RACH parameters in a System Information Block (SIB) or a Master Information Block (MIB).

14. The method of claim 7, wherein the maximum allowed RACH delay period comprises a maximum length of time that RACHing is allowed to be delayed under a predetermined radio condition.

15. A method for scheduling a forward access channel measurement occasion (FMO) in a wireless device, comprising:
determining that neither inter-radio access technology (inter-RAT) nor inter-frequency cells need to be measured based on available serving cell neighbor lists and a cell measurement rule;
using all available FMO frames to measure inter-RAT neighbor cells if only an inter-RAT neighbor list is received; and
using all available FMO frames to measure inter-frequency neighbor cells if only an inter-frequency neighbor list is received.

16. The method of claim 15, wherein if it is determined that neighbor lists are received for both inter-RAT and inter-frequency neighbor cells, further comprising:
using all available FMO frames to measure inter-RAT cells if a value for S-INTERSEARCH is less than or equal to a value for S-SEARCH-RAT; and
using all available FMO frames to measure inter-frequency cells if the value for S-INTERSEARCH is greater than the value for S-SEARCH-RAT.

17. The method of claim 16, further comprising:
determining if a random access channel (RACH) transmission mode (RACHing) is pending after FMO frames are used to measure at least one of an inter-RAT cell and an inter-frequency neighbor cell;
continuing to measure neighbor cells if RACHing is not pending; and
if RACHing is pending, determining if there are FMO frames that collide with RACHing;
receiving a serving cell selection criterion from a serving cell of the wireless device; and
if RACHing collides with the FMO frames, delaying RACHing until the end of a next FMO period when at least one of inter-frequency cells and inter-RAT cells need to be measured based on a measurement rule and a neighbor list, and upon occurrence of at least one of:
the serving cell selection criterion is less than a determined threshold;
a maximum FMO gap repeating interval is greater than a maximum allowed FMO delay period; and
there are FMO frames within a maximum allowed RACH delay period.

18. A method for scheduling a forward access channel measurement occasion (FMO) with a wireless device, comprising:
determining that neither inter-radio access technology (inter-RAT) nor inter-frequency cells need to be measured based on available serving cell neighbor lists and a cell measurement rule;
determining that the wireless device has received neighbor lists from both inter-RAT neighbor cells and inter-frequency neighbor cells;
using all available FMO frames to measure inter-RAT cells if a value for S-INTERSEARCH is less than or equal to a value for S-SEARCH-RAT; and
using all available FMO frames to measure inter-frequency cells if the value for S-INTERSEARCH is greater than the value for S-SEARCH-RAT.

19. A wireless device for scheduling a forward access channel measurement occasion (FMO) comprising:
a transmitter to transmit radio signals required to perform random access channel (RACH) transmission (RACHing) and report results of neighbor cell measurements;
a receiver to receive radio signals required to acquire information blocks, serving cell selection criteria, and measurement rule parameters, and to measure at least one of inter-frequency and inter-radio access technology (inter-RAT) neighbor cells; and
a scheduling module, coupled to the receiver, to schedule FMO frames for neighbor cell measurement in order to prioritize FMO frames that collide with at least one of a position of an information block and RACHing.

20. The wireless device of claim 19, wherein the scheduling module comprises an information block reading scheduling module to:
determine if FMO frames collide with a position of an information block received by the wireless device;
receive a serving cell selection criterion from a serving cell of the wireless device via the receiver; and
grant the FMO a higher priority over reading the information block when the FMO frames collide with the position of the information block and when the received serving cell selection criterion is less than a determined threshold value.

21. The wireless device of claim 19, wherein the information block reading scheduling module reads the information block when the FMO frames collide with the position of the information block and when the received serving cell selection criterion is greater than or equal to the determined threshold value.

22. The wireless device of claim 20, wherein the scheduling module comprises a RACH scheduling module to:
determine if there are FMO frames that are colliding with RACHing;
receive a serving cell selection criterion from a serving cell of the wireless device via the receiver; and
if RACHing collides with the FMO frames, delay RACHing until the end of a next FMO period when at least one of inter-frequency cells and inter-RAT cells need to be measured based on a measurement rule and a neighbor list, and upon occurrence of at least one of:
the serving cell selection criterion is less than a determined threshold;
a maximum FMO gap repeating interval is greater than a maximum allowed FMO delay period; and
there are FMO frames within a maximum allowed RACH delay period.

23. The wireless device of claim 22, wherein the RACH scheduling module assigns priority to RACHing over FMO when there are no FMO frames within a maximum length of time that the RACH transmission mode takes under a predetermined radio condition.

24. The wireless device of claim 19, wherein the scheduling module comprises an FMO scheduling module to:
determine that neither inter-radio access technology (inter-RAT) nor inter-frequency cells need to be measured based on available serving cell neighbor lists and a cell measurement rule;
use all available FMO frames to measure inter-RAT neighbor cells if only an inter-RAT neighbor list is received; and
use all available FMO frames to measure inter-frequency neighbor cells if only an inter-frequency neighbor list is received.

25. The method of claim 24, wherein if it is determined that neighbor lists are received for both inter-RAT and inter-frequency neighbor cells, the FMO scheduling module:
uses all available FMO frames to measure inter-RAT cells if a value for S-INTERSEARCH is less than or equal to a value for S-SEARCH-RAT; and
uses all available FMO frames to measure inter-frequency cells if the value for S-INTERSEARCH is greater than the value for S-SEARCH-RAT.
